(19) United States
(12) Patent Application Publication
(10) Pub. No.: US 2014/0310363 A1
(43) Pub. Date: Oct. 16, 2014

(54) System and Method for Collaborative Decision Making at an Airport

(71) Applicant: PASSUR Aerospace, Inc., Stamford, CT (US)

(72) Inventors: William LEBER, Stamford, CT (US); Ron DUNSKY, Stamford, CT (US); Matthew MARCELLA, Stamford, CT (US); James BARRY, Stamford, CT (US)

(73) Assignee: PASSUR Aerospace, Inc., Stamford, CT (US)

(21) Appl. No.: 14/250,115

(22) Filed: Apr. 10, 2014

Related U.S. Application Data
(60) Provisional application No. 61/810,421, filed on Apr. 10, 2013.

(51) Int. Cl. H04L 12/58

(52) U.S. Cl. CPC H04L 51/04
USPC 709/206

(57) ABSTRACT

A system and method for facilitating collaborative decision making at an airport. The system and method receive data relating to an airport from a plurality of data feed arrangements, aggregate the data, format the aggregated data for display to users and transmit the formatted aggregated data to the users for display.

### PRIORITY CLAIM/INCORPORATION BY REFERENCE

This application claims the benefit of U.S. Provisional Patent Application 61/810,421 filed on Apr. 10, 2013 and entitled “Integrated, collaborative operational dashboard for aviation executives and enthusiasts” and is expressly incorporated herein, in its entirety, by reference.

### BACKGROUND

A persistent challenge in the field of aviation is to have multiple stakeholders at an airport communicate in a timely fashion. This challenge is complicated by the fact that airports have spent millions of dollars and many years building different types of technologies to solve different types of issues. Thus, any system for communicating at an airport must overcome these legacy technology “silos.”

### SUMMARY OF THE INVENTION

A method for receiving data relating to an airport from a plurality of data feed arrangements, aggregating the data, formatting the aggregated data for display to users and transmitting the formatted aggregated data to the users for display.

A system having a non-transitory computer readable storage medium that stores a set of instructions and a processor configured to execute the instructions. The instructions cause the processor to receive data relating to an airport from a plurality of data feed arrangements, aggregate the data, format the aggregated data for display to users and transmit the formatted aggregated data to the users for display.

A non-transitory computer readable storage medium that stores a set of instructions executable by a processor. The instructions cause the processor to receive data relating to an airport from a plurality of data feed arrangements, aggregate the data, format the aggregated data for display to users and transmit the formatted aggregated data to the users for display.

### DESCRIPTION OF THE DRAWINGS

FIG. 1 shows an exemplary system for providing aggregated data and facilitating communication among multiple stakeholders for an airport facility.

FIG. 2 shows an exemplary collaborative decision making (“CDM”) system.

FIG. 3 shows a first exemplary display that may be displayed to users.

FIG. 4 shows a second exemplary display that may be displayed to users.

FIG. 5 shows a third exemplary display that may be displayed to users.

FIG. 6 shows an exemplary method for collaborative decision making at an airport.

### DETAILED DESCRIPTION

The present invention may be further understood with reference to the following description and to the appended drawings, wherein like elements are referred to with the same reference numerals. The exemplary embodiments of the present invention comprise a collaborative decision making (“CDM”) system and communications network that is designed to aggregate multiple information sets from different sources. This aggregation facilitates instant communication, coordination and sharing of consistent information among different parties logged in within and between organizations. The information may be viewed through the use of programs that access and display files and other data available on the communications network such as, for example, a web browser. The exemplary embodiments provide a technology solution to the communication issue and a new way to organize workflow and business practices at an airport. The exemplary embodiments maximize efficiencies and airport performance in real time, ensuring that whatever the changes in demand on the operation, resources will be available to meet them.

The system may be accessible by a plurality of users such as, for example, tower operators, airport operations personnel, airlines, terminal operators, Federal Aviation Administration (“FAA”) personnel, off-site parties (e.g., operators at other airports, local airport authority personnel, etc.), etc. One exemplary embodiment of the present invention is described as a web based system. However, those skilled in the art will understand that there may be any number of other manners of implementing the present invention in embodiments that are not web based. It is also noted that the terms “information” and “data” are used interchangeably in this description.

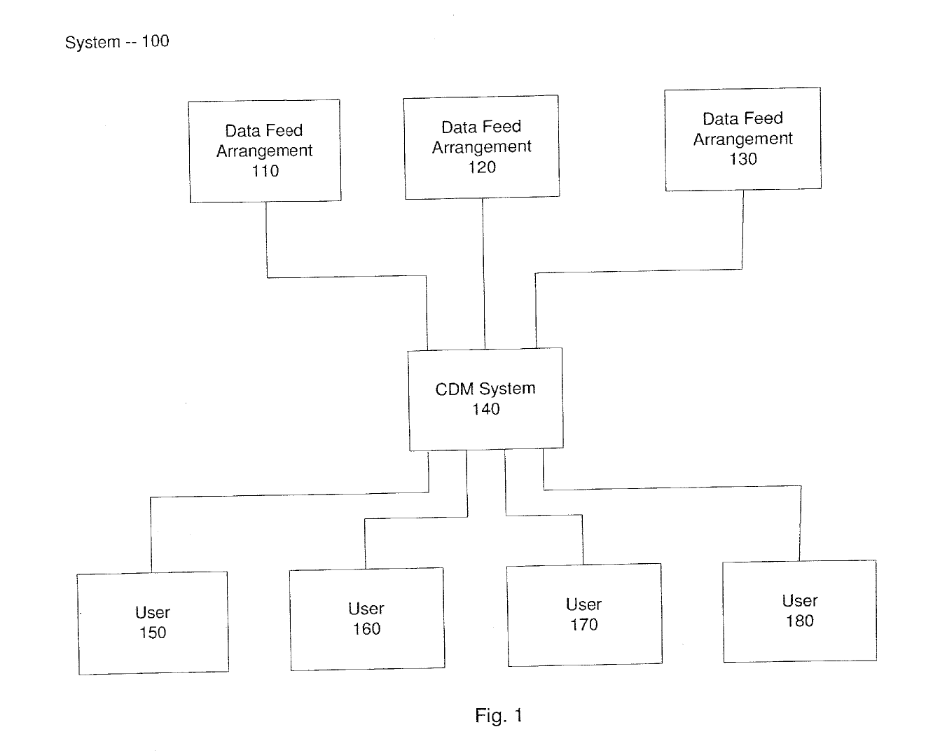

FIG. 1 shows an exemplary system 100 for providing aggregated data and facilitating communication among multiple stakeholders for an airport facility. The exemplary system 100 includes three data feed arrangements 110-130. These data feed arrangements 10-30 provide data to a CDM system 140. Examples of the data provided by the data feed arrangements 110-130 to the CDM system 140 will be described in greater detail below. The CDM system 140 may aggregate this input data and format the data for display to the different stakeholders that are identified as users 150-180 in FIG. 1. The CDM system 40 will then allow the different users 150-180 to communicate based on viewing the same set of data. The operation of each of the components of the system 100 will be described in greater detail below.

It should be noted that the data feed arrangements 110-130 and the users 150-180 are shown in FIG. 1 as being directly connected to the CDM system 140. It should be understood that the connection between these components may be direct connections or that there may be a communications network (wired or wireless), such as a local area network, Internet, etc. that is interposed between the various components that allows the components to communicate.

The data feed arrangements 110-130 may be any system that provides data related to the airport. Examples of data feed arrangements may include government data feeds such as FAA data feeds, National Weather Service feeds, etc. Other types of data feeds may be third-party private data feeds, airport specific data feeds, owner/operator data feeds, etc. To provide some specific examples, the airport may have a passive radar installation that is operated by a third party (e.g., the PASSUR radar operated by PASSUR Aerospace of Stamford, Conn.) that provides a multitude of information about aircraft that are in the vicinity of the airport. Another exemplary data feed arrangement be a surface management data feed that provides information on aircraft that are on the surface of the airport. Another exemplary data feed arrangement may be a system that provides gate arrival information. A final example of a data feed arrangement may be an airline system that provides schedule information. As described above, there may be many disparate systems or data feed arrangements at an airport that provide many different types of information. Some systems may have provided overlapping information. It is noted that the source of the data is not relevant to the exemplary embodiments. In addition, the illustration of three data feed arrangements 110-130 is only exemplary. There may be less or more data feed arrangements providing data to the CDM system 140.

The CDM system 140, while shown as a separate component, may be a module or other component that is included in other hardware and/or software. The actual physical implementation of the CDM system 140 is not critical to the exemplary embodiment. Thus, any component that incorporates the functionality described herein for the CDM system 140 is sufficient.

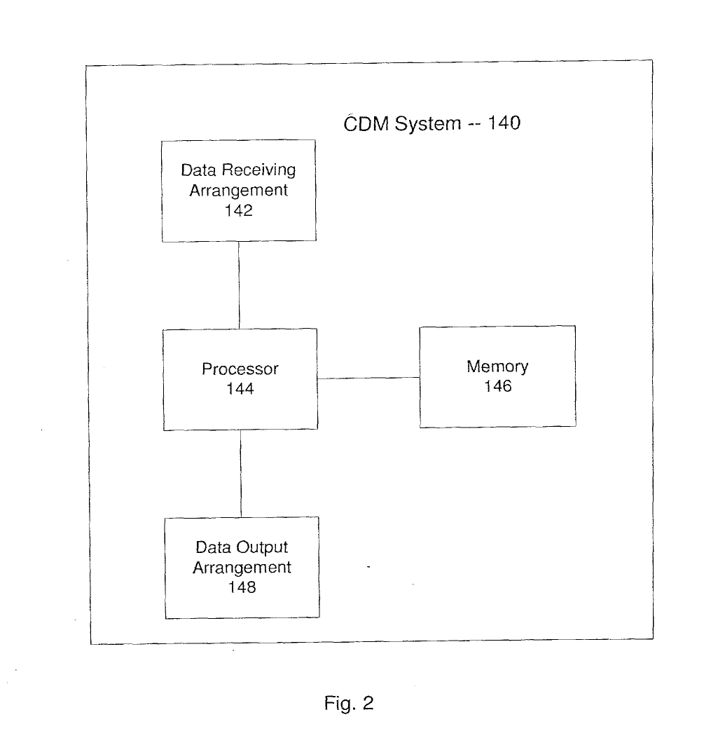

FIG. 2 shows an exemplary CDM system 140. This exemplary embodiment of the CDM system 140 includes a data receiving arrangement 142, a processor 144, a memory 146 and a data output arrangement 148. In one exemplary embodiment, the CDM system 140 and its associated components 142-148 may be embodied in a server device. The data receiving arrangement 142 is configured to receive the data from the data feed arrangements 110-130, but may also be configured to receive other input data from, for example, the users 150-180 as will be described in greater detail below. This data is provided to the processor 144 to be aggregated and formatted for display to the users 150-180 to facilitate the communication among the users 150-180. The memory 146 may be used to store any received data and may also store instructions or a computer program that are used to instruct the operations of the CDM system 140. When the processor 144 has aggregated and formatted the data, this information may be provided to the data output arrangement 148 that is configured to output the formatted data to the users 150-180. The embodiment of a server is only exemplary and those skilled in the art will understand that the functionality described herein for the CDM system 140 may be included in any type of computing device and that the functionality may be distributed to multiple devices.

The users 150-180 stations may be, for example, personal computers (PCs), tablets, phablets, smart phones or any other computing platforms. Typically, each user will be assigned a username and a password so that only authenticated users may access the CDM system 140. The mechanisms for distributing usernames and passwords and the use thereof to access computing systems are generally well known and will not be further described herein. Once a user 150-180 has logged into the CDM system 140, the user 150-180 has access to the data that is aggregated by the CDM system 140. As will be described in greater detail below, this aggregated data, while it may be generated by many disparate data feed arrangements, may be presented to the users 150-180 in a consistent manner by the CDM system 140.

The following will provide exemplary displays that may be displayed to the users 150-180 to show information for the airport. Those skilled in the art will understand that other information in addition to, or exclusive from, the exemplary information may also be displayed. In these examples, the airport of interest is Boston's Logan Airport that has an airport code of BOS. Those skilled in the art will understand that the use of the Boston airport is only exemplary and that the CDM system 140 may be used for any airport.

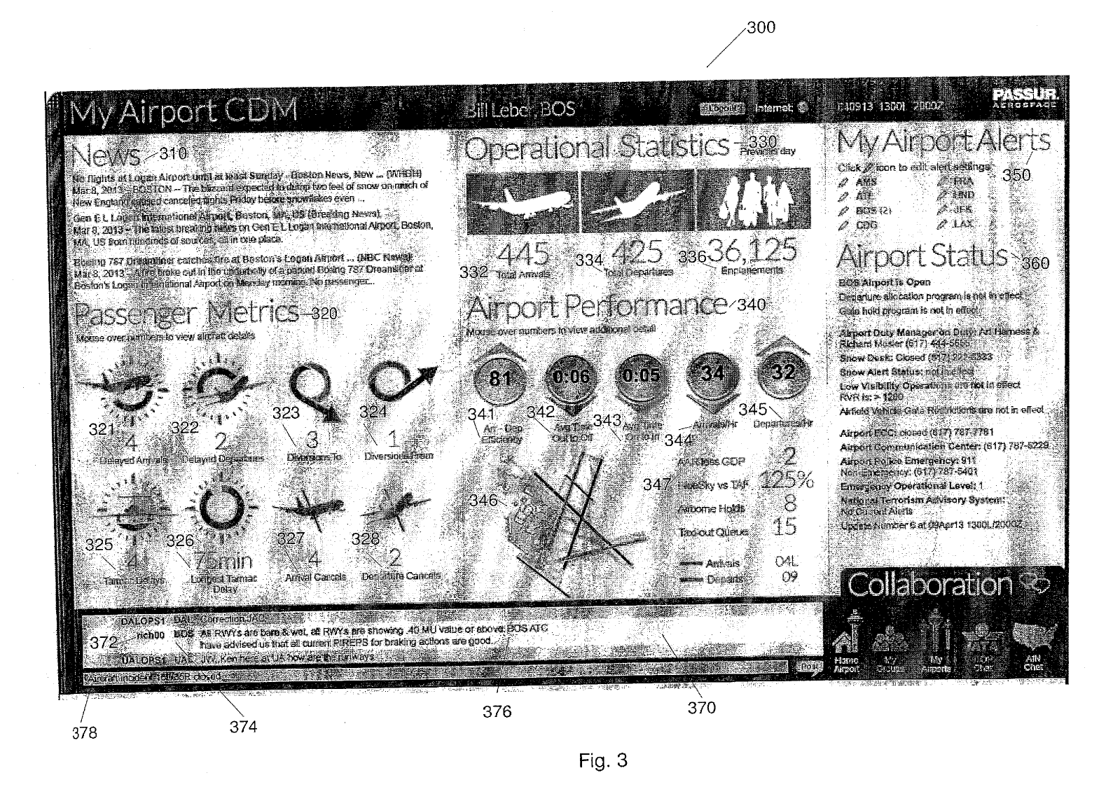

FIG. 3 shows a first exemplary display 300 that may be displayed to users 150-180. The display 300 provides an example of data from different data feeds that are aggregated and displayed in a single display. For example, in news area 310, there are three news stories that relate to the Boston airport. Each of these news stories may come from a separate data feed, which in this example are, WHDH (a local Boston station), Breaking News (a national news service) and NBC News (also a national news service). The user may click on or otherwise select any of the news stories to display the full news story.

In a passenger metrics area 320, information related to passenger experiences at the airport may be displayed. These metrics may include fields for delayed arrivals 321, delayed departures 322, diversions to 323, diversions from 324, tarmac delays 325, longest tarmac delay 326, arrival cancellations 327 and departure cancellations 328. It should be recognized that each of these types of information may come from the same or different data feeds. It should also be recognized that the data may be displayed in the fields in any type of format, e.g., text, icons, etc. The fields may also be color-coded to convey additional types of information.

In an operational statistics area 330, information related to the previous days operation of the airport may be displayed. These statistics may include fields for the total arrivals 332, the total departures 334 and a number of passenger enplanements 336. Similar to the passenger metrics, these statistics may come from the same or different data feeds.

In an airport performance area 340, information related to the current airport performance may be displayed. This performance information may include fields for an arrival and departure efficiency 341, an average time out-to-off 342, an average time on-to-in 343, a number of arrivals per hour 344, a number of departures per hour 345, a runway configuration 346, and various additional information 347. These fields may include some examples of icons and colors that convey additional information. For example, the average time from out-to-off shows a text value of 0:06 (6 minutes). However, the icon shows a downward pointing arrow indicating that the average time is dropping. While shown in gray scale in the drawings, this icon may also be colored green to indicate that the average time is dropping, which is a positive development. In another example, the runway configuration field 346 may show the active runways in green and the not active runways in red.

As described above, each of these individual pieces of information may come from one of the data feed arrangements 110-130. The information may be information that is directly measured such as the total arrivals 332 or information that is derived from other data such as the average time out-to-off 342. As also described above, this data is not generated by the CDM system 140, but rather, the CDM system 140 receives this information from the various data feeds 110-130 and aggregates the data and formats it for display in an easily understandable format so different users 150-180 may see what is happening at the airport. As will be described with reference to further exemplary display screens, the users 150-180 may be able to select any one of these pieces of information to see additional detail concerning the data.

It should be noted that it may be possible that the users may be able to individually format the display screen 300 based on their own preferences. For example, the user may desire to move the location of the news area 310 to a different area on the display 300. In another example, the user may desire to show different types of metrics in the passenger metrics area 320. A setup page or dropdown menu may allow the user to select from a set of metrics that may be displayed in the passenger metrics area 320. Since each user 150-180 may login to the CDM system 140, the user's preferences may be stored and the display 300 may be displayed on any device that is used to login based on the user's preferences.

In another exemplary embodiment, the display 300 may not be individually settable because the airport may want each user 150-180 to see the same information in the same format. This may aid users in communicating because each user will see the same data in the same format. In a further example, users 150-180 may be separated into classes (e.g., airline personnel, terminal operators, etc.) and the display 300 may be customized for the class of user.

Continuing with the exemplary display 300, my airport alerts area 350 allows a user 150-180 to select a number of airports for which the user 150-180 will receive alerts. In this example, the user has selected Amsterdam (AMS), Atlanta (ATL), Boston (BOS), Charles De Gaulle airport in Paris (CDG), Frankfurt (FRA), Tokyo Haneda (HND), John F. Kennedy airport in New York (JFK) and Los Angeles (LAX). If any alerts are pending for the selected airports, the user may select that airport and show the alert. An example of an alert display will be described with reference to a further exemplary display.

The exemplary display 300 also includes an airport status area 360 that includes various status information for the airport. This status information may include, for example, the general status of the airport (e.g., open), information about personnel on duty, phone numbers to call in case of specific actions, terrorism status, etc.

The exemplary display 300 also includes a chat area 370. The chat area allows the users to communicate with each other and to view the communications among other users. In this example, the chat area shows the user 372, the relative location 374 or function of the user and the communication 376 that the user posted. The chat area 370 also includes post area 378 for the user to post a message to the chat.

Each user will login into the CDM system 140 using a username and password, although it is possible for multiple users to share usernames or passwords as will be described below. In this example, the first post is by user UALOPS1 having a location of UAL and a message of “J W. Ken here at UA how are the runways.” The location UAL indicates that the user is related to United Airlines. The username UALOPS1 is descriptive in that the user is an operational person at United Airlines. It is not necessary that the username be descriptive. Thus, when this username and location posts a message, other users generally understand who posted the message. As stated above, each United Airlines operations person may not have a unique username and/or password, but multiple persons may share the same usernames and passwords because the username and password generally identifies the function of the person posting a message.

In response to this message from user UALOPS1, the user rich00 having a location BOS has posted a response message, “All RWYs are bare & wet, all RWYs are showing 0.40 MU value or above. BOS ATC have advised us that all current PIREPS for braking actions are good.” Thus, the user UALOPS1 has received a response to their message and they understand that the response has come from a user at the Boston airport because the location is BOS.

The next message is from user DALOPS1 having a location of DAL. This location is indicative of a user located at Dallas Love Field. This illustrates that a user does not need to be located in Boston to have access to the CDM system 40 for the Boston airport. There may be many good reasons why an operations person at a different airport needs to know what is happening in Boston. In this example, the user from Dallas has posted a message for all other users to see. This message is unrelated to the conversation between the UALOPS1 user and the rich00 user. As will be described with reference to a further exemplary display screen, the chat area 370 may be expanded to view more of the running communications in order for users to understand the context of the communications. This example also shows that multiple conversations may be occurring at the same time.

The display 300 may be used by the different users 150-180 to understand the current state of the airport and communicate necessary messages to the different users. For example, a first user looking at the exemplary display 300 may see that the longest tarmac delay 326 is 75 minutes. This user may be in charge of FAA compliance for an airline. FAA rules dictate that airlines are fined for tarmac delays that are too long. The user may be concerned that the tarmac delays are approaching the time where fines may be levied and may communicate with other personnel that are logged into the CDM system 140 to understand the reasons for the tarmac delays and to attempt to mitigate the tarmac delays.

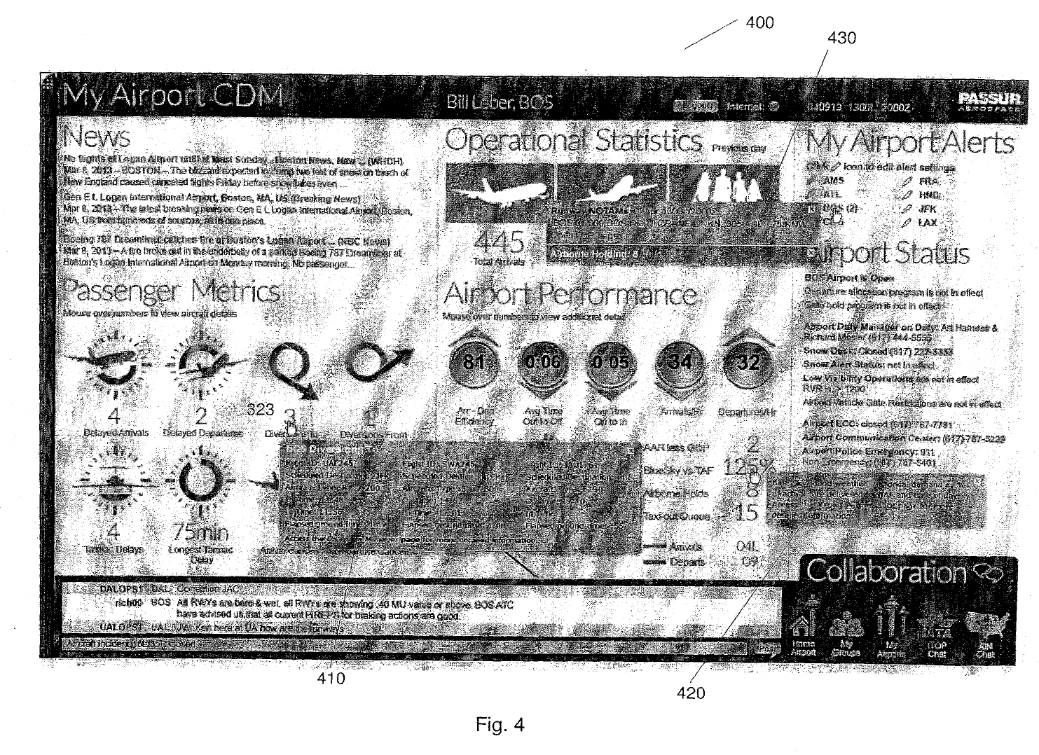

FIG. 4 shows a second exemplary display 400 that may be displayed to users. The display 400 is generally the same as display 300, except that it shows examples of more detailed information that may be displayed to users when they select one or more of the types of information that are displayed. The user may select any of the information fields to receive additional information. The fields selected in display 400 are only exemplary.

In a first example, the user has selected the diversions to information 323 to receive further data. In this example, the diversions to information 323 shows there are three (3) diverted to flights, e.g., three flights that were not originally scheduled to land at Boston that will now be landing at Boston. By selecting the diverted to information 323 by, for example, scrolling over the information, clicking on the information, etc., the information box 410 appears and provides additional details concerning each of the diversions. In this example, the further information includes the Flight ID, the scheduled destination, the aircraft type, the On-time (assuming the aircraft has landed), the In-time (assuming the aircraft has reached the gate) and the elapsed ground time. The information box 410 also directs the user to the Diversion Manager page for more information. The Diversion Manager may be a separate page that is hosted by the CDM system 40 or may be a separate stand-alone system that handles diversion information.

The display 400 also shows that the user selected to view additional information for the Blue Sky vs. TAF (Terminal Area Forecast). This information is shown in the information box 420. The data for this entry is shown as 125%. The information box 420 explains that this data is the Blue Sky (good weather) historical demand as a percentage of the actual rate delivered for the TAF and time of day. The information box also directs the user to the Airport Performance page for more detailed information.

In a last example for display 400, the user has selected the alerts for Boston (BOS) that brings up information box 430. As shown on the display 400, there are two (2) alerts for BOS. The information box 430 shows these two alerts, Runway NOTAMS and Airborne Holding. The user may also select to receive more information on any of these alerts by selecting the appropriate link within the alert.

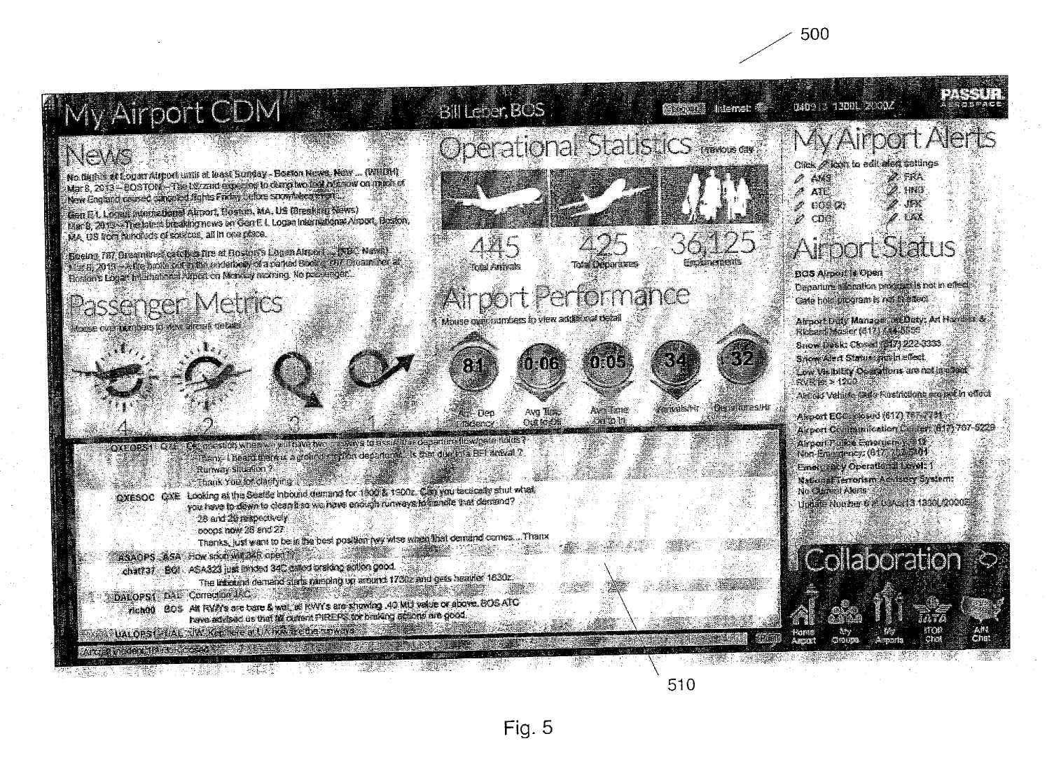

FIG. 5 shows a third exemplary display 500 that may be displayed to users. In this example, the user has selected to enlarge the chat area 510 so that the user may see more of the conversations that are occurring. This enlarged chat area allows the user to more fully understand the context of the posted messages.

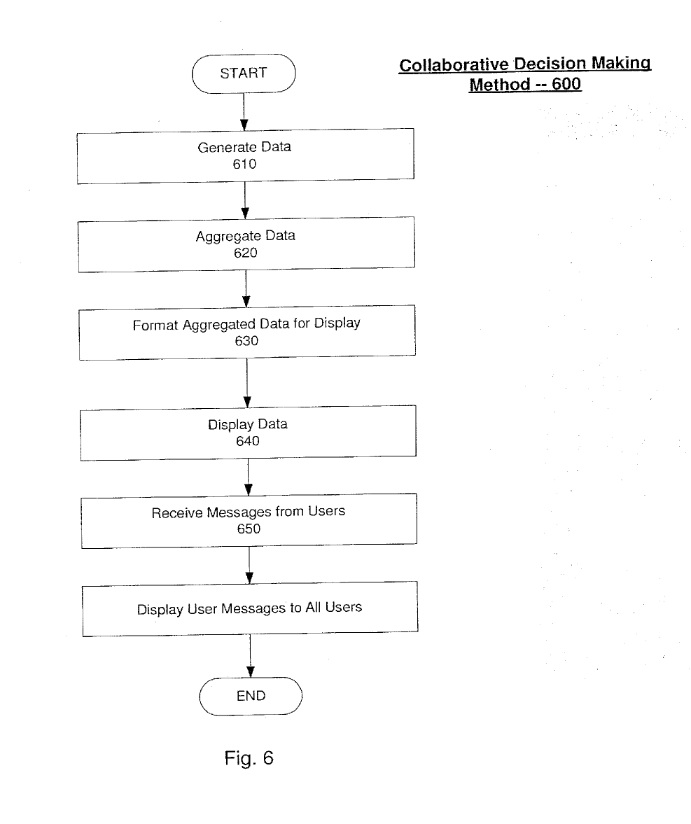

FIG. 6 shows an exemplary method 600 for facilitating collaborative decision making at an airport. The method 600 will be described with reference to the components of system 100 of FIG. 1. In step 610, data for the airport is generated. In the system 100, the data feed arrangements 110-130 generate the data. As described above, the data could be any data related to airport operation such as weather data, operational data, surface data, etc.

In step 620, the CDM system 140 receives the data from each of the data feed arrangements 110-130 and aggregates the data. For example, the CDM system 140 may receive many different types of data from many disparate airport systems. The CDM system 140 aggregates this data from the many disparate systems into a comprehensible set of data based on the type of data that will be displayed. In step 630, the CDM system 140 formats the data for display. The displays 300-500 described above are examples of different types of displays that may be formatted by the CDM system 140.

In step 640, the data is displayed to the users 150-180. As described above, the data may be displayed in any number of formats. In one example, the user device-executes a web browser that retrieves a web page from a web server of the CDM system 140 and displays the web page on the user device. However, those skilled in the art will understand that there are many other manners of displaying the data to the users 150-180.

In step 650, the CDM system 140 receives messages from the users 150-180. Examples of messages were provided in FIGS. 3 and 5 described above. In step 660, the CDM system 140 formats the received messages and displays the received messages for all the users to view. It should be understood that the method 600 is an ongoing process as the CDM system 140 continually receives new/updated data and messages and displays the new/updated data and messages to the users 150-180.

The exemplary embodiments described above allow a collaborative decision making (“CDM”) system to be implemented within the context of existing airport systems. The exemplary CDM systems aggregate multiple information sets from the disparate airport systems, thereby facilitating instant communication, coordination and sharing of consistent information among different parties logged in within and between organizations.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Mac platform and MAC OS, etc. In a further example, the example embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving data relating to an airport from a plurality of data feed arrangements;
aggregating the data;
formatting the aggregated data for display to users; and
transmitting the formatted aggregated data to the users for display.

2. The method of claim 1, further comprising:
receiving a message from one from one of the users; and
formatting the message to be displayed with the aggregated data.

3. The method of claim 2, wherein the message is a plurality of messages from a plurality of users, wherein the plurality of messages are formatted to be displayed with the aggregated data.

4. The method of claim 1, wherein the formatted aggregated data is formatted for display a common format for all users.

5. The method of claim 1, wherein at least two of the plurality of data feed arrangements are under the control of different entities, wherein these different entities are also different from an entity that operates the airport.

6. The method of claim 1, wherein the formatted aggregated data is one of displayed as text data, icon data and color-coded data.

7. The method of claim 1, wherein the data is one of news related to the airport, passenger metric data, airport operational statistics, airport performance data and airport status data.

8. The method of claim 1, further comprising:
receiving a request from one of the users for additional information related to the formatted aggregated data; and
transmitting additional data to the one of the users related to at least a portion of the formatted aggregated data.

9. A system, comprising:
a non-transitory computer readable storage medium that stores a set of instructions; and
a processor configured to execute the instructions to cause the processor to:
receive data relating to an airport from a plurality of data feed arrangements;
aggregate the data;
format the aggregated data for display to users; and
transmit the formatted aggregated data to the users for display.

10. The system of claim 9, wherein the instructions further cause the processor to:
receive a message from one from one of the users; and
format the message to be displayed with the aggregated data.

11. The system of claim 10, wherein the message is a plurality of messages from a plurality of users, wherein the plurality of messages are formatted to be displayed with the aggregated data.

12. The system of claim 9, wherein the formatted aggregated data is formatted for display a common format for all users.

13. The system of claim 9, wherein at least two of the plurality of data feed arrangements are under the control of different entities, wherein these different entities are also different from an entity that operates the airport.

14. The system of claim 9, wherein the formatted aggregated data is one of displayed as text data, icon data and color-coded data.

15. The system of claim 9, wherein the data is one of news related to the airport, passenger metric data, airport operational statistics, airport performance data and airport status data.

16. The system of claim 9, wherein the instructions further cause the processor to:
receive a request from one of the users for additional information related to the formatted aggregated data; and
transmit additional data to the one of the users related to at least a portion of the formatted aggregated data.

17. A non-transitory computer readable storage medium that stores a set of instructions executable by a processor, wherein the instructions cause the processor to:
receive data relating to an airport from a plurality of data feed arrangements;
aggregate the data;
format the aggregated data for display to users; and
transmit the formatted aggregated data to the users for display.
